(19) United States
(12) Patent Application Publication
(10) Pub. No.: US 2026/0147180 A1
(43) Pub. Date: May 28, 2026

(54) OPTICAL APPARATUS

(71) Applicant: CANON KABUSHIKI KAISHA, Tokyo (JP)

(72) Inventors: MASATO SHIONO, Kanagawa (JP); KOHEI UEMURA, Kanagawa (JP)

(21) Appl. No.: 19/357,606

(22) Filed: Oct. 14, 2025

(30) Foreign Application Priority Data
Nov. 28, 2024 (JP) 2024-207142

(51) Int. Cl. G02B 7/10; G02B 27/64; G03B 17/14; G02B 7/09

(52) U.S. Cl. CPC G02B 7/10; G02B 27/646; G03B 17/14; G02B 7/09

(57) ABSTRACT

An optical apparatus includes a cam barrel having a cam groove portion, a first movable member having a first cam follower, a second movable member having a second cam follower, a biasing unit for applying a biasing force to the second movable member. The cam groove portion has a first cam surface and a second cam surface that move the first cam follower in an optical axis direction as the cam barrel rotates, and a third cam surface that is provided at a different position in a radial direction from the first cam surface or the second cam surface on the cam barrel and moves the second cam follower that has received the biasing force, in the optical axis direction as the cam barrel rotates.

### BACKGROUND

### Field of the Technology

The disclosure relates to one or more embodiments of an optical apparatus that movably supports an optical element, such as a lens.

### Description of the Related Art

As disclosed in PCT International Patent Publication No. WO 2020/137563, some optical apparatuses use a single cam groove portion to move two lens units, thereby reducing the length of the cam barrel in which the cam groove portion is formed. A cam follower is provided on a movable member that holds the lens units, and a biasing force is applied to the movable member to bring the cam follower into contact with the cam surface of the cam groove portion without any play.

### SUMMARY

One or more embodiments of an optical apparatus according to one or more aspects of the disclosure may include a cam barrel having a cam groove portion, a first movable member having a first cam follower, a second movable member having a second cam follower, a biasing unit for applying a biasing force to the second movable member. The cam groove portion has a first cam surface and a second cam surface that move the first cam follower in an optical axis direction as the cam barrel rotates, and a third cam surface that is provided at a different position in a radial direction from the first cam surface or the second cam surface on the cam barrel and moves the second cam follower that has received the biasing force, in the optical axis direction as the cam barrel rotates.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of an imaging system including an interchangeable lens unit according to this embodiment.

FIG. 2 is a block diagram illustrating the configuration of the imaging system.

FIG. 3 is a sectional view of an interchangeable lens unit at a wide-angle end according to this embodiment.

FIG. 4 is a sectional view of the interchangeable lens unit at a telephoto end according to an embodiment.

FIG. 5 is an exploded perspective view of third and fourth zoom units according to this embodiment.

FIGS. 6A and 6B illustrate a cam barrel according to this embodiment.

FIG. 7 illustrates the third and fourth zoom units according to this embodiment.

FIG. 8 is an exploded perspective view of the third zoom unit according to this embodiment.

FIG. 9 is a sectional view of a cam barrel according to this embodiment.

### DESCRIPTION OF THE EMBODIMENTS

Referring now to the accompanying drawings, a description will be given of embodiments according to the disclosure.

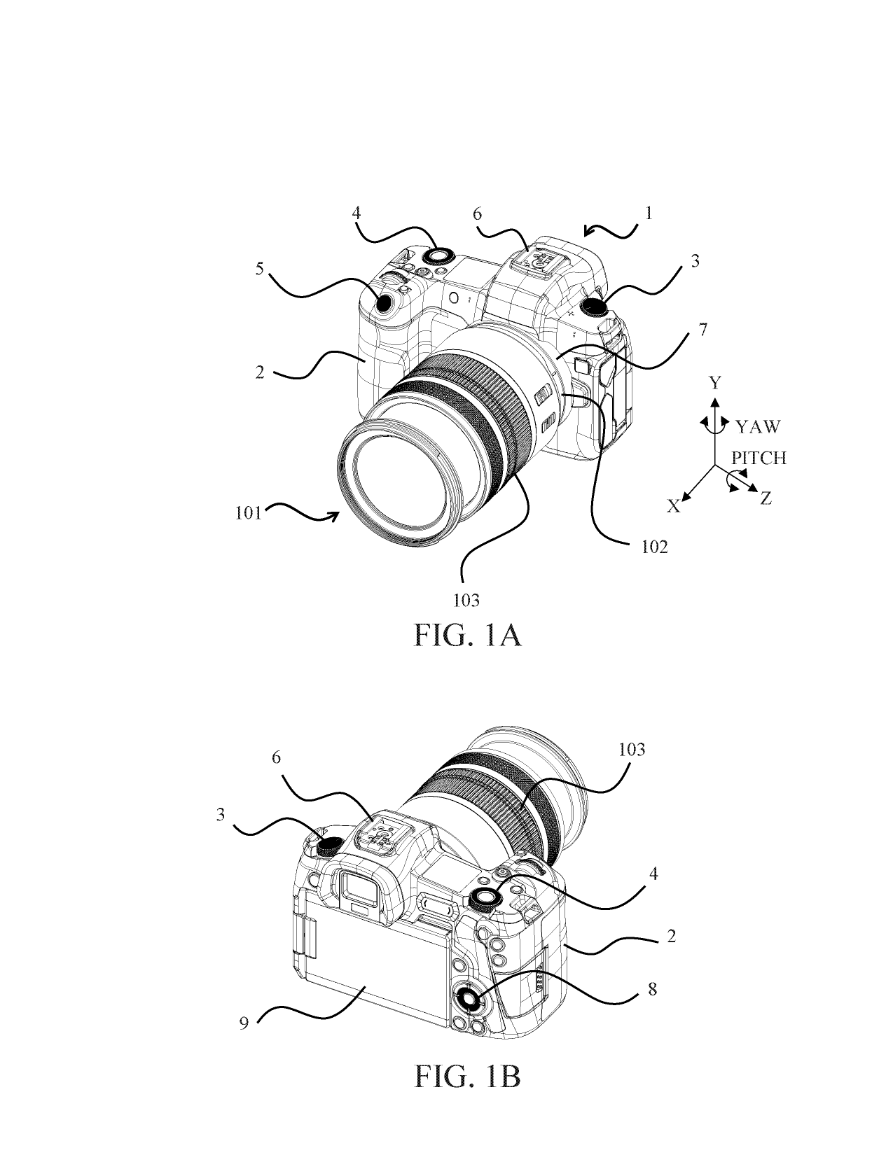

FIGS. 1A and 1B illustrate the exterior of an imaging system that includes an interchangeable lens unit 101 as an optical apparatus according to this embodiment of the disclosure, and a digital camera (referred to as the camera body hereinafter) 1 to which the interchangeable lens unit 101 is detachably attached. FIGS. 1A and 1B illustrates the imaging system as viewed from the diagonally front side (object side) and diagonally rear side (image plane side), respectively. While this embodiment will discuss an optical apparatus that is attachable to and detachable from the camera body, the optical apparatus may be integrated into the camera body.

As illustrated in FIG. 1A, a direction in which the optical axis of the imaging optical system housed in the interchangeable lens unit 101 extends will be referred to as an X-axis direction (optical axis direction), and directions orthogonal to the X-axis direction will be referred to as a Z-axis direction (horizontal direction) and a Y-axis direction (vertical direction). In the following description, the Z-axis and Y-axis directions will be collectively referred to as Z/Y-axes directions. A rotating direction around the Z-axis will be referred to as a pitch direction, and a rotating direction around the Y-axis will be referred to as a yaw direction. The pitch and yaw directions (hereinafter collectively referred to as pitch/yaw directions) are rotating directions around two mutually orthogonal axes, the Z and Y-axes.

The camera body 1 includes a grip portion 2 on the left side when viewed from the front (right side when viewed from the rear) that allows the user to hold the camera body 1 in his right hand. A power operation unit 3 is located on the top surface of the camera body 1. When the user turns on the power operation unit 3 while the camera body 1 is in the power-off state, the camera body 1 is powered on, and a computer program such as focus unit origin detection processing is executed, placing the camera in an imaging standby state. When the user turns off the power operation unit 3 while the camera body 1 is in the power-on state, the camera body 1 is powered off.

The top surface of the camera body 1 includes a mode dial 4, release button 5, and accessory shoe 6. The user can switch an imaging mode by rotating the mode dial 4. The imaging mode includes a manual still image capturing mode, which allows the user to freely set an imaging condition such as a shutter speed and an aperture value (F-number), an automatic still image capturing mode, which automatically obtains the proper exposure, and a moving image capturing mode for moving image capturing. The user can half-press the release button 5 to initiate an imaging preparation operation such as autofocus (AF) and auto-exposure (AE) controls, and fully press the release button 5 to initiate an imaging operation. An accessory such as an external flash can be attachable to and detachable from the accessory shoe 6.

The interchangeable lens unit 101 includes a lens mount 102 that is mechanically and electrically connectable to a camera mount 7 provided on the camera body 1. A lens mount 102 and camera mount 7 are made of a conductive metal material and can be mechanically coupled via bayonet coupling.

The interchangeable lens unit 101 houses an imaging optical system that forms an object image by capturing an image of light from an object. A zoom operation ring 103 is provided on the outer circumference of the interchangeable lens unit 101 as an operation member that can be rotated around the optical axis by user operation. As the user rotates the zoom operation ring 103, the zoom unit constituting the imaging optical system moves within a zoom range from a wide-angle end to a telephoto end. Thereby, a zoom state (angle of view) corresponding to the rotation angle of the zoom operation ring 103 can be set.

In the interchangeable lens unit 101 according to this embodiment, by rotating the zoom operation ring 103 beyond the wide-angle end toward the opposite side from the telephoto end, the imaging optical system enters a retracted state in which it is not in use. In the retracted state, the length of the interchangeable lens unit 101 in the optical axis direction becomes minimum.

As illustrated in FIG. 1B, a rear operation unit 8 and a display unit 9 are provided on the rear surface of the camera body 1. The rear operation unit 8 includes a plurality of buttons and dials to which a variety of functions are assigned. When the camera body 1 is powered on and the still or moving image capturing mode is set, the display unit 9 displays a live-view image of the object captured by the image sensor (described below). The display unit 9 also displays the imaging condition (imaging parameter) such as the shutter speed and the aperture value. The user can change the setting value of the imaging parameter by operating the rear operation unit 8 while viewing the imaging parameter display. The rear operation unit 8 includes a playback button for instructing playback of a recorded captured image, and by operating the playback button the captured image can be played back and displayed on the display unit 9. The display unit 9 may include a touch sensor and have the same function as that of the rear operation unit 8.

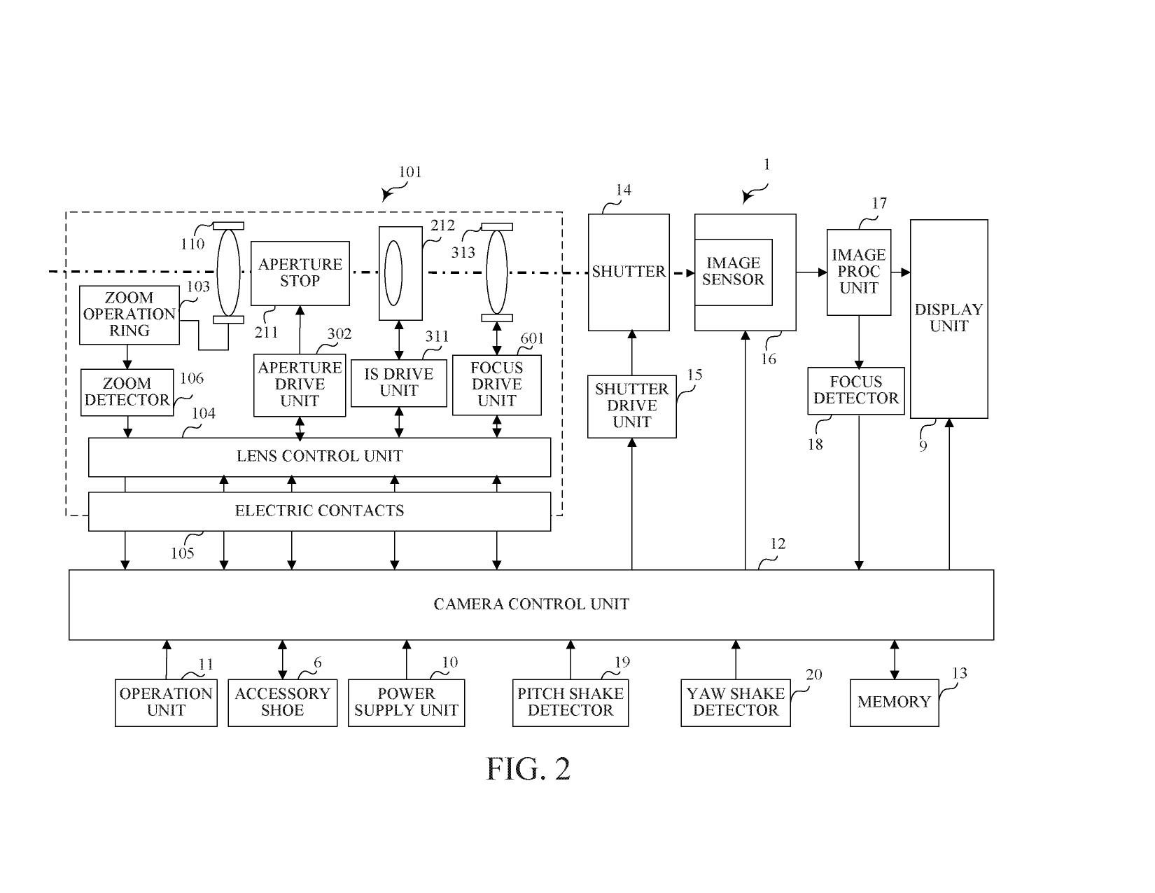

FIG. 2 illustrates the electrical and optical configuration of the imaging system. The camera body 1 includes a power supply unit 10 that supplies power to the camera body 1 and the interchangeable lens unit 101, and an operation unit 11 that includes the power operation unit 3, the mode dial 4, the release button 5, the rear operation unit 8, and the touch panel function of the display unit 9. In this embodiment, control of the entire system of the camera body 1 and interchangeable lens unit 101 is performed by the mutual cooperation of a camera control unit 12 provided in the camera body 1 and a lens control unit 104 provided in the interchangeable lens unit 101. Each of the camera control unit 12 and the lens control unit 104 has a built-in computer for controlling the camera body 1 and the interchangeable lens unit 101, respectively, and the entire system of the camera body 1 and the interchangeable lens unit 101 is controlled by their mutual cooperation.

The camera control unit 12 reads and executes a computer program stored in a memory 13. In doing so, the camera control unit 12 communicates various control signals, data, and the like with the lens control unit 104 via a communication terminal of the electrical contact 105 provided on the lens mount 102. The electrical contact 105 includes a power terminal that supplies power from the power supply unit 10 to the interchangeable lens unit 101.

The imaging optical system in the interchangeable lens unit 101 is connected to the zoom operation ring 103 and includes a zoom unit 110 that changes an angle of view by moving the zoom lens in the optical axis direction, and an aperture unit 301 that adjusts a light amount. The imaging optical system further includes an image stabilizing unit 113 that reduces image shake by moving (shifting) a shift lens, which serves as an image stabilizing element, in the Z/Y-axes directions orthogonal to the optical axis. The imaging optical system further includes a focus unit 116 that performs focusing by moving a focus lens in the optical axis direction. The interchangeable lens unit 101 includes an aperture drive unit 302 that drives the aperture unit 301, an image stabilizing (IS) drive unit 311 that drives the image stabilizing unit 113, and a focus drive unit 601 that drives the focus unit 116.

The camera body 1 includes a shutter unit 14, a shutter drive unit 15, an image sensor 16, an image processing unit 17, and the camera control unit 12. The shutter unit 14 controls the exposure amount of the image sensor 16. The image sensor 16 photoelectrically converts (captures) an object image formed by the imaging optical system and outputs an imaging signal. The image processing unit 17 generates an image signal by performing various image processing on the imaging signal. The display unit 9 displays the image signal (live-view image) output from the image processing unit 17, displays an imaging parameter as described above, and plays back and displays a captured image recorded in the memory 13 or a recording medium (not illustrated).

The camera control unit 12 controls the focus drive unit 601 according to the imaging preparation operation (half-pressing operation of the release button 5) on the operation unit 11. For example, in a case where an AF operation is instructed, a focus detector 18 uses the image signal generated by the image processing unit 17 to generate a focus signal indicating the focus state of the object image and sends it to the camera control unit 12. The focus drive unit 601 sends information on the current position of the focus unit 116 to the camera control unit 12. The camera control unit 12 calculates the focus drive amount using the focus state and the current position of the focus unit 116 and sends the focus drive amount to the lens control unit 104. The lens control unit 104 moves the focus unit 116 to the target position in the optical axis direction via the focus drive unit 601 to achieve an in-focus state.

The focus drive unit 601 includes a focus motor as an actuator, and a photo-interrupter that detects when the focus unit 116 is located at the origin position. The focus motor may be a stepping motor, DC motor, vibration motor, servo motor, or the like. The photo-interrupter has a configuration in which light emitted from a light emitter is received by a light receiver, and detects that the focus unit 116 has reached the origin position when the light is shielded by the focus unit 116 that has moved to the origin position. Instead of the photo-interrupter, a photo-reflector that receives reflected light from a reflective surface, or a potentiometer that contacts a conductive pattern and outputs an electrical signal according to its position, may be used.

The camera control unit 12 controls the drive of the aperture unit 301 and shutter unit 14 via the aperture drive unit 302 and shutter drive unit 15 in accordance with the setting values of the aperture value and shutter speed received from the operation unit 11. For example, in a case where an AE control operation is instructed, the camera control unit 12 performs a photometric calculation using a luminance signal generated by the image processing unit 17. In a case where an imaging instruction operation (such as fully pressing the release button 5) is performed for the operation unit 11, the camera control unit 12 controls the aperture drive unit 302 based on the photometric calculation result. The camera control unit 12 controls the driving of the shutter unit 14 via the shutter drive unit 15, and controls the exposure amount of the image sensor 16.

The camera body 1 includes a pitch shake detector 19 and a yaw shake detector 20, each of which detects camera shake caused by hand shake or the like. Each of the pitch shake detector 19 and yaw shake detector 20 uses an angular velocity sensor (vibration gyro) and an angular acceleration sensor to detect camera shake in the pitch direction (direction around the Z-axis) and yaw direction (direction around the Y-axis), and output a shake signal.

The camera control unit 12 uses the shake signal from the pitch shake detector 19 to calculate the shift position of the image stabilizing unit 113 in the Y axis direction, and uses the shake signal from the yaw shake detector 20 to calculate the shift position of the image stabilizing unit 113 in the Z axis direction. The camera control unit 12 moves the image stabilizing unit 113 to a target position in the Z and Y-axes via the image stabilizing drive unit 311 in accordance with the calculated shift positions in the pitch and yaw directions, reducing image blur during exposure and live-view image display.

The interchangeable lens unit 101 includes the zoom operation ring 103 that the user rotates to change the angle of view of the imaging optical system, and a zoom detector 106 that detects the angle of the zoom operation ring 103. The zoom detector 106 detects the angle of the zoom operation ring 103 as an absolute value and is implemented using, for example, a potentiometer. The angle of the zoom operation ring 103 detected by the zoom detector 106, i.e., zoom position information on the angle of view, is transmitted to the lens control unit 104 and reflected in the various controls performed by the camera control unit 12 described above. Various information such as zoom position information is recorded together with the captured image in the memory 13 or an unillustrated recording medium.

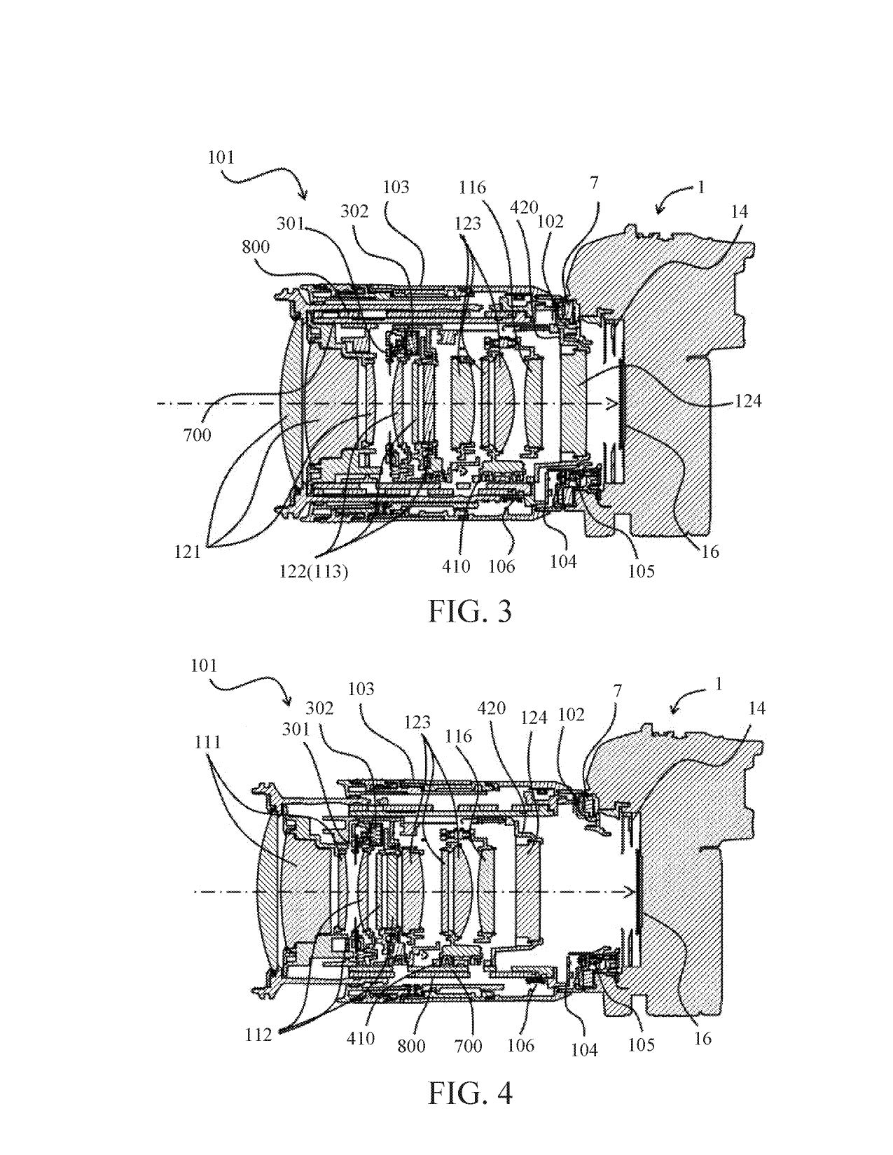

The main components of the interchangeable lens unit 101 will be described using FIGS. 3 and 4. FIGS. 3 and 4 illustrates XY cross sections including the optical axis at the wide-angle end and telephoto end of the interchangeable lens unit 101, respectively. In each figure, the optical axis of the imaging optical system is indicated by an alternate long and short dash line.

This embodiment uses a five-unit optical system as the imaging optical system. The zoom unit 110 consists of, in order from the object side, a first zoom unit 121, a second zoom unit 122 including an image stabilizing unit 113, a third zoom unit 123, and a fourth zoom unit 124. A focus unit 116 is disposed between the third zoom unit 123 and the fourth zoom unit 124. The imaging optical system may have a configuration other than that described above. The focus unit 116 may be included in the zoom units. The imaging optical system may further include a fixed unit that does not move for zooming.

A guide barrel 700 serving as a guide member is a fixed component fixed to the lens mount 102 via an unillustrated fixed barrel. Bayonet claws (not illustrated) are provided on the outer circumferential surface of the guide barrel 700 at regular intervals in the circumferential direction (around the optical axis). Circumferential grooves (not illustrated) are provided on the inner circumferential surface of a cam barrel 800. The cam barrel 800 is connected to the zoom operation ring 103. Therefore, as the user rotates the zoom operation ring 103, the bayonet claws become engaged with the circumferential grooves, and cause the cam barrel 800 to rotate around the optical axis while restricting movement in the optical axis direction.

The guide barrel 700 has a plurality of linear guide groove portions that guide linear movement in the optical axis direction of the zoom unit 110 while restricting the zoom unit 110 from rotating around the optical axis. The cam barrel 800 also has a plurality of cam groove portions that correspond to the first to fourth zoom units 121 to 124 and have mutually different cam shapes (change rate of the cam lift to the rotation). The cam followers are provided for the first to fourth zoom units 121 to 124, and each cam follower is engaged with its corresponding linear guide groove portion and cam groove portion. Therefore, as the user rotates the zoom operation ring 103 to rotate the cam barrel 800, the first to fourth zoom units 121 to 124 move in the optical axis direction while their rotations around the optical axis are restricted due to the engagements between the linear guide groove portions of the cam followers and the cam groove portions.

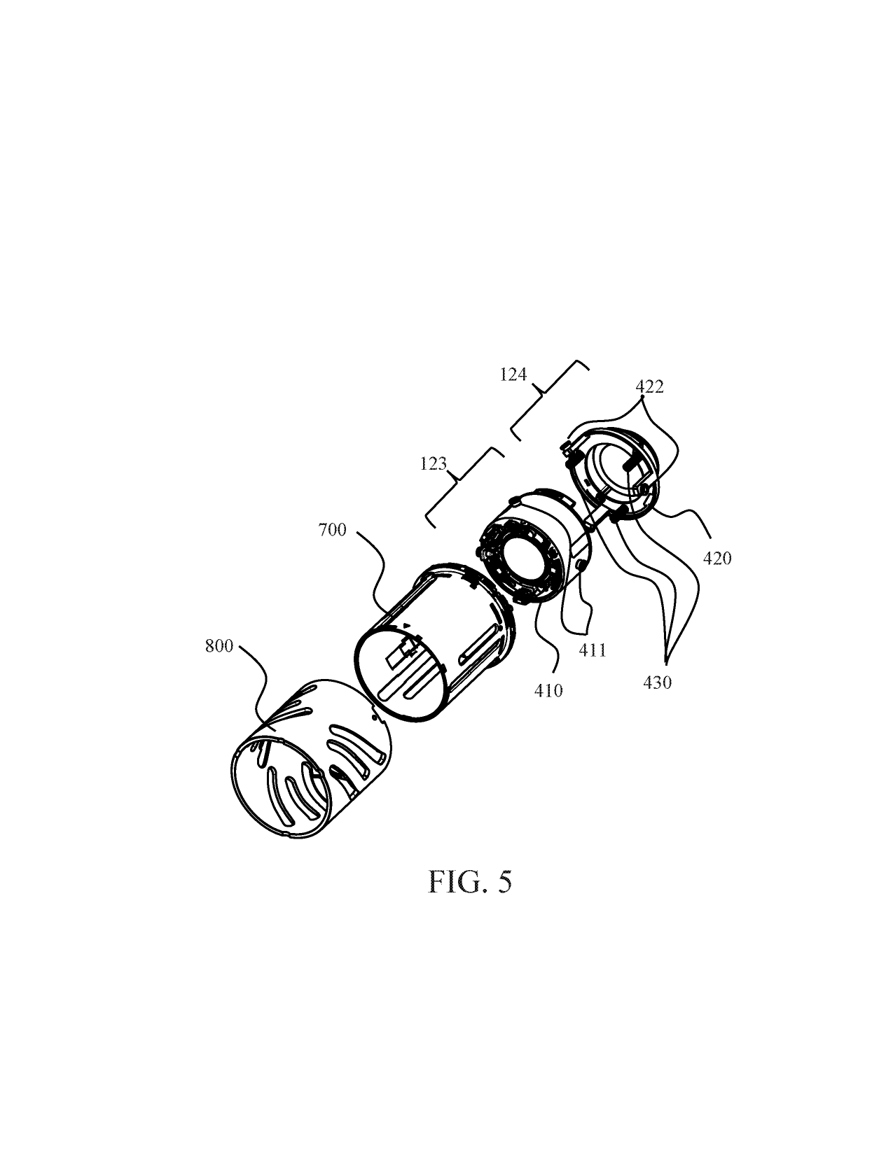

FIG. 5 is an exploded view of the third zoom unit 123, the fourth zoom unit 124, the cam barrel 800, and the guide barrel 700, when viewed from the oblique object side. The guide barrel 700 has linear guide groove portions arranged at regular intervals around the circumferential direction that restrict the third zoom unit 123 and the fourth zoom unit 124 from rotating around the optical axis and guide linear movement in the optical axis direction of the third zoom unit 123 and the fourth zoom unit 124. The cam barrel 800 has first cam groove portions 801 and second cam groove portions 802 formed at regular intervals around the circumferential direction, each having a different cam curve, that correspond to the third zoom unit 123 and the fourth zoom unit 124.

The focus unit 116 is housed within the third-unit holding barrel 410, which serves as a first movable member and holds the third zoom unit 123 including the first optical element. A first cam follower 411 is provided on the outer circumferential surface of the third-unit holding barrel 410. A second cam follower 422 is provided on the outer circumferential side of an arm portion extending toward the object side of the fourth-unit holding frame 420, which serves as a second movable member and holds the fourth zoom unit 124 including the second optical element.

Each of the first cam follower 411 and the second cam follower 422 is engaged with a corresponding one of the linear guide groove portions in the guide barrel 700 and a corresponding one of the first cam groove portions 801 and second cam groove portions 802 in the cam barrel 800, respectively. Therefore, as the cam barrel 800 is rotated, the third and fourth zoom units 123 and 124 move in the optical axis direction while their rotations around the optical axis are restricted by the engagements of the linear guide groove portions of the first and second cam followers 411 and 422 with the first and second cam groove portions 801 and 802, respectively.

Three biasing members (coil springs) 430 serving as biasing units are arranged at regular intervals in the circumferential direction between the third-unit holding barrel 410 and the fourth-unit holding frame 420. The biasing members 430 generate a biasing force in a direction that separates the third-unit holding barrel 410 and the fourth-unit holding frame 420 from each other in the optical axis direction.

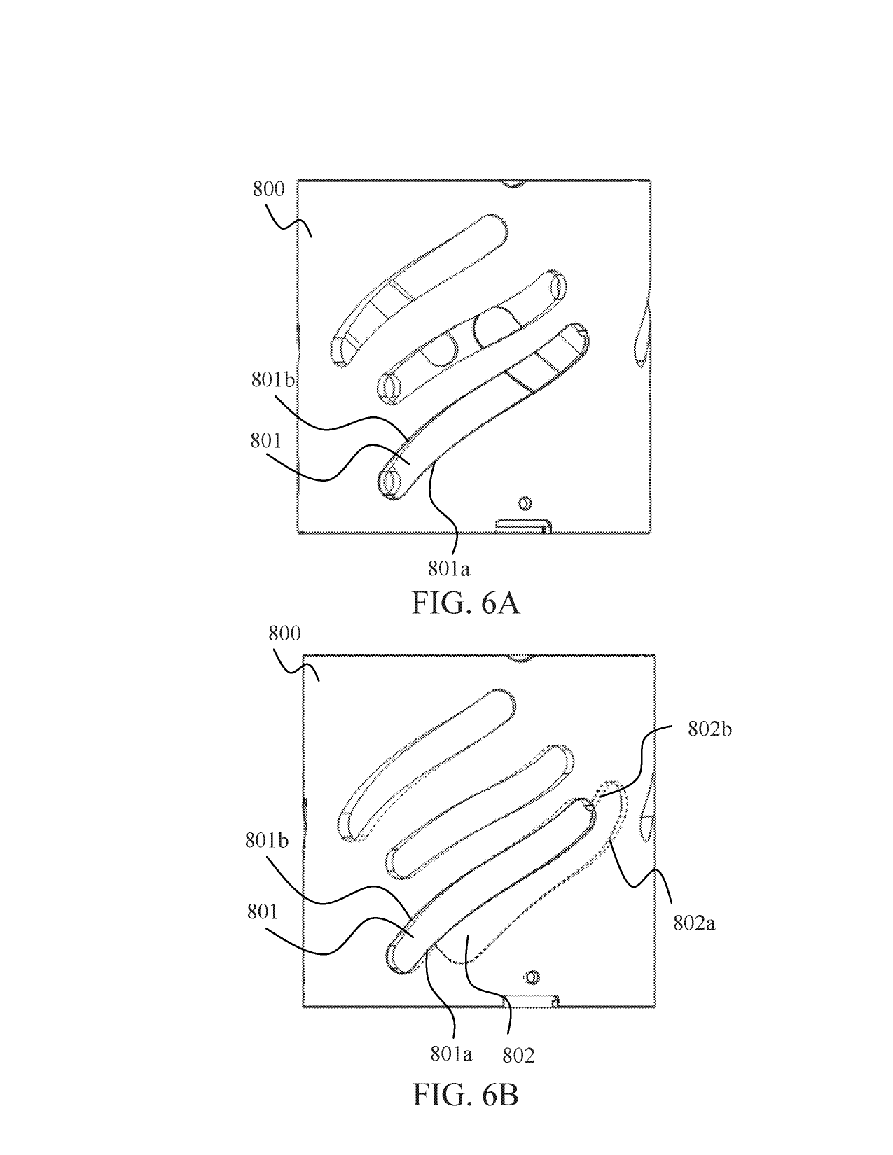

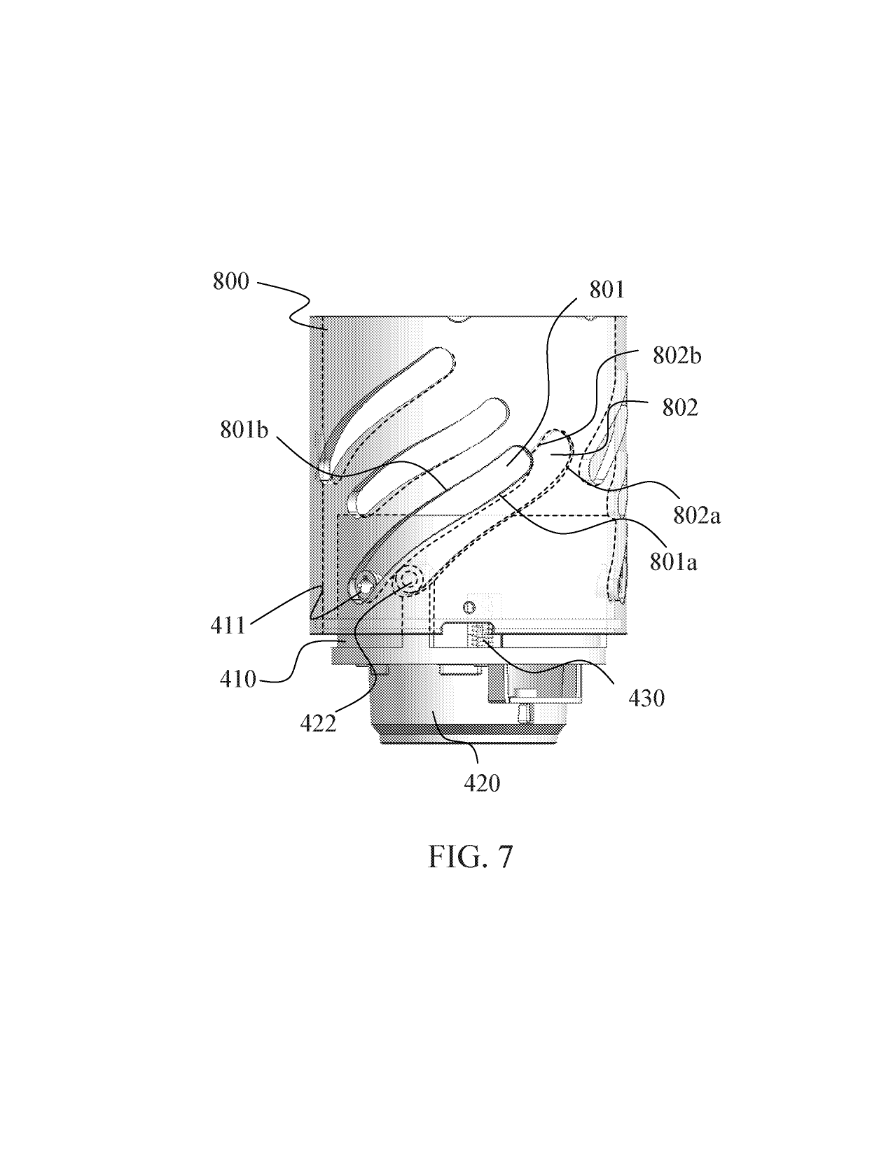

FIG. 6A illustrates the cam barrel 800 when viewed from the outer circumference side. The first cam groove portion 801 is formed in the circumferential wall portion of the cam barrel 800. FIG. 6B illustrates, with a broken line, the second cam groove portion 802 formed on the inner circumference of the cam barrel 800 when viewed from the outer circumference. The second cam groove portion 802 is formed so that its part on the object side (upper side in the figure) extends toward the object side beyond the first cam groove portion 801. FIG. 7 illustrates the assembled state of the cam barrel 800, the third zoom unit 123, and the fourth zoom unit 124. The broken line indicates the part of the circumferential wall portion of the cam barrel 800 that is not visible from the outer circumference. FIG. 9 illustrates a cross section passing through the first cam follower 411 and the second cam follower 422 illustrated in FIG. 7.

The first cam groove portion 801 has a first cam surface 801a and a second cam surface 801b on one side and the other side in the groove width direction, respectively. The first cam surface and the second cam surface may be arranged in the opposite direction to that illustrated in the figure in the groove width direction of the first cam groove portion 801. The second cam groove portion 802 has a third cam surface 802a on the opposite side (one side) in the groove width direction to the first cam surface 801a, and has a fourth cam surface 802b as a wall portion surface on the other side in the groove width direction in the part on the object side.

Arranging the first cam groove portion 801 and the second cam groove portion 802 as close as possible in the optical axis direction can reduce the length of the cam barrel 800 in the optical axis direction. On the other hand, in order to ensure the strength of each of the first cam groove portion 801 and the second cam groove portion 802, it is conceivable to space the first cam groove portion 801 and the second cam groove portion 802 from each other to some extent, but this would increase the length of the cam barrel 800.

Therefore, this embodiment forms the second cam groove portion 802 so that the second cam groove portion 802 overlaps the first cam groove portion 801 in the circumferential direction and in the optical axis direction, except for the part on the object side. In other words, the second cam groove portion 802 is formed so as to have an inner surface (third cam surface 802a) on only one side in the groove width direction, excluding a part on the object side. More specifically, the first cam groove portion 801 is formed to penetrate the circumferential wall portion of the cam barrel 800. The second cam groove portion 802 is formed on the inner peripheral side of the circumferential wall portion so as not to penetrate the circumferential wall portion of the cam barrel 800 (so as to have a bottom surface). The first cam surface 801a is provided on the outer circumference side of the circumferential wall portion of the cam barrel 800, and the third cam surface 802a is provided on the inner circumference side of the circumferential wall portion.

Thus, the first cam groove portion 801 and the second cam groove portion 802 are formed as a single groove portion that is continuous (not partitioned) in the groove width direction of these cam groove portions, and the first cam surface 801a and the third cam surface 802a are provided at different positions in the radial direction of the cam barrel 800. In a case where the first cam surface 801a is used as the second cam surface, the second cam surface and the third cam surface 802a are provided at different radial positions on the cam barrel 800. Therefore, in the radial direction of the cam barrel 800, the position where the first cam follower 411 contacts the first cam surface 801a and the second cam surface 801b is different from the position where the second cam follower 422 contacts the third cam surface 802a.

The outer diameter of the first cam follower 411 is set so that it can be movably fitted (lightly press-fit) between the first cam surface 801a and the second cam surface 801b of the first cam groove portion 801. Therefore, the first cam follower 411 contacts the first cam surface 801a or the second cam surface 801b, and moves in the optical axis direction due to the lift. At this time, there is no optically significant difference in the position of the third zoom unit in the optical axis direction between when the first cam follower 411 moves due to the lift of the first cam surface 801a and when it moves due to the lift of the second cam surface 801b.

On the other hand, the second cam follower 422 comes into contact with the third cam surface 802a of the second cam groove portion 802 due to the biasing force of the biasing member 430, and moves in the optical axis direction due to the lift of the third cam surface 802a.

The above structure can arrange the first cam groove portion 801 and the second cam groove portion 802 so that they overlap each other in the optical axis direction and the length of the cam barrel 800 can be reduced compared to the case where the first cam groove portion and the second cam groove portion are arranged spaced apart from each other in the optical axis direction.

In this embodiment, the first cam follower 411 and the second cam follower 422 are arranged at different phases from each other in the circumferential direction of the cam barrel 800. Thereby, in a case where the first cam groove portion 801 and the second cam groove portion 802 are formed so that they overlap each other, the length of the cam barrel 800 in the optical axis direction can be further reduced regardless of the range of the cam followers.

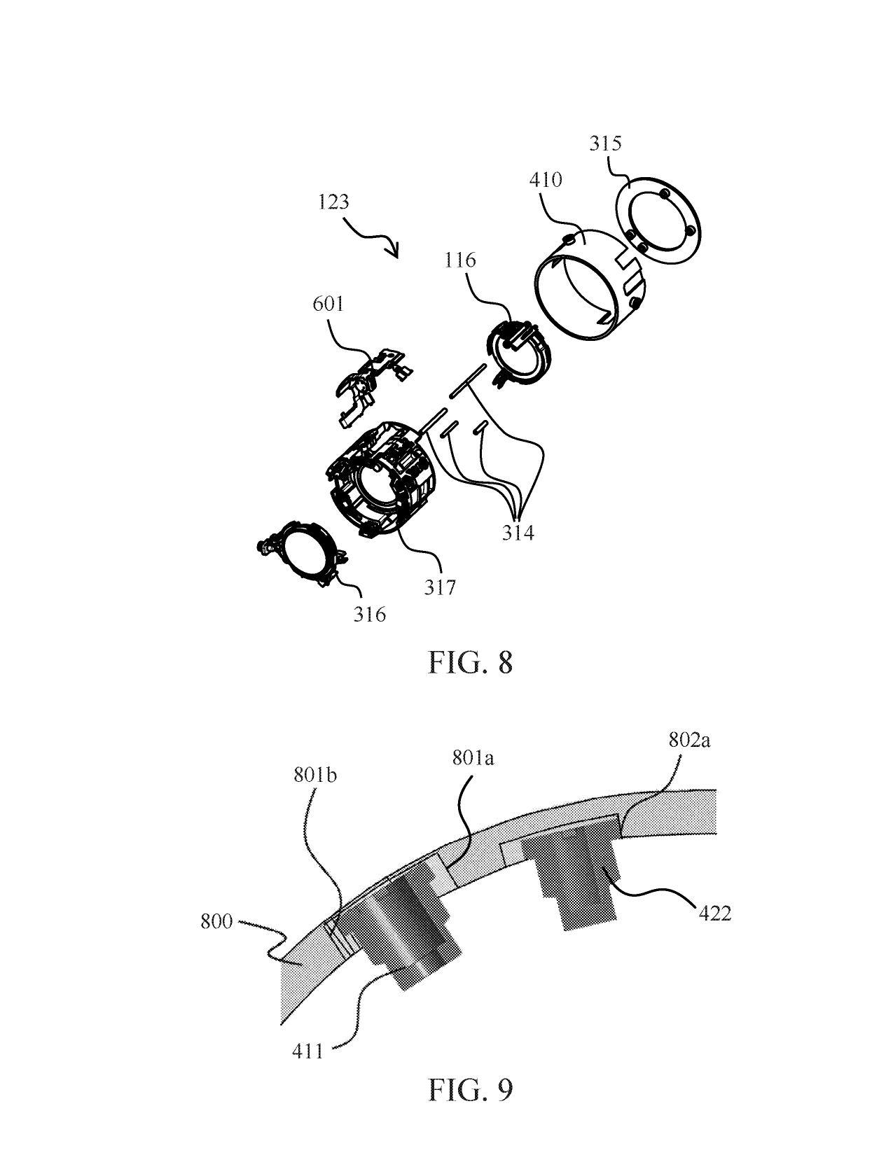

FIG. 8 is an exploded view of the third zoom unit 123. The third zoom unit 123 includes a third-unit holding barrel 410, a holding frame 316 that holds a lens closest to the object in the third zoom unit 123, and a holding frame 317 that holds a lens in the third zoom unit 123 that is closer to the image plane the lens closest to the object. The third-unit holding barrel 410 further includes the focus unit 116, the focus drive unit 601 that drives the focus unit 116, and a plurality of guide bars 314 that linearly guide the focus unit 116 in the optical axis direction. A cover member 315 is provided at the end of the third-unit holding barrel 410 on the image side.

As described above, the biasing member 430 generates a biasing force in a direction that moves the third zoom unit 123 and the fourth zoom unit 124 away from each other in the optical axis direction. Therefore, the torque generated by the user operating the zoom operation ring 103 is influenced by the biasing force generated by the biasing member 430. In a case where the mass (weight) of the zoom unit is large, the biasing force of the biasing member 430 may be increased to match the mass of that zoom unit. As a result, the operating torque required to move the zoom unit increases, and the operability deteriorates. Wear is more likely to occur in the cam groove portions that contact the cam followers provided on the zoom unit.

In this embodiment, the first mass of the third-unit holding barrel 410, which holds multiple elements such as the third zoom unit 123, focus unit 116, and focus drive unit 601, is greater than the second mass of the fourth-unit holding frame 420, which mainly holds only one element, the fourth zoom unit 124. Furthermore, the difference in mass between them is significant. That is, the mass movably supported by the first cam follower 411 is significantly greater than the mass movably supported by the second cam follower 422.

In the second cam groove portion 802 in this embodiment, the fourth cam surface 802b facing the third cam surface 802a is provided only in a part on the object side. Hence, in order to stably move the fourth-unit holding frame 420 (second cam follower 422) along the third cam surface 802a, the biasing force of the biasing member 430 may be set to a sufficient magnitude relative to the mass of the fourth-unit holding frame 420.

On the other hand, as described above, in the third-unit holding barrel 410, the first cam follower 411 is movably fitted between the first cam surface 801a or the second cam surface 801b of the first cam groove portion 801. Therefore, even if the biasing force of the biasing member 430 on the third-unit holding barrel 410 is insufficient (or absent), the third-unit holding barrel 410 can be stably moved in the optical axis direction by the first cam surface 801a or the second cam surface 801b. Therefore, in a case where there is a large difference in mass between the third-unit holding barrel 410 and the fourth-unit holding frame 420, the biasing force of the biasing member 430 can be reduced by using one having a larger mass as the third-unit holding barrel 410. In other words, the biasing force of the biasing member 430 is sufficient to match the mass of the smaller mass. This structure can prevent an increase in the operating torque for moving the zoom unit and increased wear on the cam groove portions.

In this embodiment, the biasing member 430 is a separate member from the third-unit holding barrel 410 and the fourth-unit holding frame 420, but may be provided as a resilient portion (elastic portion) as part of one of the third-unit holding barrel 410 and the fourth-unit holding frame 420.

A biasing member as a retraction spring that retracts the fourth-unit holding frame 420 toward the image side may be disposed between the fourth-unit holding frame 420 and the end of the guide barrel 700 on the image plane side, thereby generating a biasing force that separates the fourth-unit holding frame 420 toward the image plane side from the third-unit holding barrel 410. In this case, since the third-unit holding barrel 410 does not receive a biasing force from the biasing member, the first cam follower 411 is not biased toward either the first cam surface 801a or the second cam surface 801b of the first cam groove portion 801, and the biasing force to be generated by the biasing member can be reduced.

This embodiment can reduce the length of cam barrel 800 in the optical axis direction while suppressing an increase in the drive load due to the biasing force of the zoom unit.

In the above embodiment, the first and second cam groove portions corresponding to the third and fourth zoom units are provided on the cam barrel, but a structure similar to this embodiment can be adopted in a case where the first and second cam groove portions corresponding to the two moving units are provided on the cam barrel.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment can provide an optical apparatus that can reduce the drive load on the movable member due to the biasing force.

This application claims the benefit of Japanese Patent Application No. 2024-207142, which was filed on November 28, 2024, and which is hereby incorporated by reference herein in its entirety.

What is claimed is:

1. An optical apparatus comprising:
a cam barrel having a cam groove portion;
a first movable member having a first cam follower;
a second movable member having a second cam follower;
a biasing unit for applying a biasing force to the second movable member,
wherein the cam groove portion has a first cam surface and a second cam surface that move the first cam follower in an optical axis direction as the cam barrel rotates, and a third cam surface that is provided at a different position in a radial direction from the first cam surface or the second cam surface on the cam barrel and moves the second cam follower that has received the biasing force, in the optical axis direction as the cam barrel rotates.

2. The optical apparatus according to claim 1, wherein the cam groove portion is formed as a single continuous groove portion in a groove width direction of the cam groove portion.

3. The optical apparatus according to claim 1, wherein the cam groove portion has a first cam groove portion having the first cam surface and the second cam surface, and a second cam groove portion formed as a continuous groove portion in a groove width direction of the first cam groove portion and having the third cam surface.

4. The optical apparatus according to claim 3, wherein the first cam groove portion and the second cam groove portion are formed in a circumferential wall portion of the cam barrel,
wherein the first cam groove portion is formed to penetrate the circumferential wall portion in the radial direction, and
wherein the second cam groove portion is formed not to penetrate the circumferential wall portion in the radial direction.

5. The optical apparatus according to claim 3, wherein the first cam groove portion and the second cam groove portion have overlap parts in the optical axis direction.

6. The optical apparatus according to claim 1, wherein the third cam surface has a cam shape different from the first cam surface or the second cam surface.

7. The optical apparatus according to claim 1, wherein the first cam follower is movably fitted between the first cam surface and the second cam surface.

8. The optical apparatus according to claim 1, wherein the first cam follower supports a first mass including the first movable member and an element held by the first movable member,
wherein the second cam follower supports a second mass including the second movable member and an element held by the second movable member, and
wherein the first mass is larger than the second mass.

9. The optical apparatus according to claim 1, wherein the first cam follower and the second cam follower are arranged at different phases from each other in a direction around an optical axis.

10. The optical apparatus according to claim 1, wherein the biasing means is disposed between the first movable member and the second movable member.

11. The optical apparatus claimed in claim 1, wherein the first movable member holds a first optical element, and
wherein the second movable member holds a second optical element.
